(19) United States
(12) Patent Application Publication
(10) Pub. No.: US 2026/0277437 A1
(43) Pub. Date: Sep. 17, 2026

(54) TRIGGERED DATA ARRANGEMENT METHOD AND MEMORY DEVICE

(71) Applicant: SILICON MOTION INC., Hsinchu County (TW)

(72) Inventor: Po-Wei WU, Hsinchu County (TW)

(21) Appl. No.: 19/558,491

(22) Filed: Mar. 6, 2026

(30) Foreign Application Priority Data
Mar. 12, 2025 (TW) 114109250

(51) Int. Cl. G06F 3/06

(52) U.S. Cl. CPC G06F 3/0608; G06F 3/0613; G06F 3/0659; G06F 3/0679

(57) ABSTRACT

The present disclosure provides a triggered data arrangement method and a memory device. The memory device includes a memory controller and a memory module. The memory module includes multiple blocks. The triggered data arrangement method includes: in response to an electronic device detecting a first trigger event, triggering, by the electronic device, the memory controller to execute an aggressive garbage collection operation, in which the aggressive garbage collection operation is used to maximize a number of spare blocks of multiple first blocks of a first type among the blocks; and in response to a second trigger event, stopping, by the memory controller, the aggressive garbage collection operation, in which the aggressive garbage collection operation includes executing an uninterrupted garbage collection operation before the second trigger event occurs.

### CROSS-REFERENCE TO RELATED APPLICATION

This application claims priority to Taiwan Application Serial Number 114109250, filed on Mar. 12, 2025, which is herein incorporated by reference in its entirety.

### BACKGROUND

### Field of Invention

The present disclosure relates to a data arrangement method of a memory device. More particularly, the present disclosure relates to a data arrangement method of a memory device triggered by an electronic device.

### Description of Related Art

In some related technologies, when a user intends to use a smartphone to record a video in a specific format (such as a ProRes video) that may generate a large amount of data, the user may connect a storage device (such as a solid state drive) to the smartphone, so as to directly store or record the video in the specific format into the storage device. In order to achieve this method, the storage device is likely to be required to support specific specifications, such as data transmission speed (for example: 220 MB per second, 440 MB per second, etc.), power consumption (for example: 4.5 W), etc.

When performing large-scale data writing operations, a current storage device may operate in dirty mode, that is, the storage device will simultaneously or alternately perform writing operations and garbage collection operations. However, it is difficult for the storage device in dirty mode to meet the specific specifications required by the above method in practice, so the video is forced to be interrupted before the recording is completed, which is a bad experience for the user. Therefore, there is a need to resolve the above problem.

### SUMMARY

An aspect of present disclosure relates to a triggered data arrangement method. The triggered data arrangement method is applicable to an electronic device and a memory device. The memory device includes a memory controller and a memory module. The memory module includes a plurality of blocks. The triggered data arrangement method includes: triggering, by a processing circuit of the electronic device, the memory controller to execute an aggressive garbage collection operation in response to the processing circuit detecting a first trigger event, wherein the aggressive garbage collection operation is used to maximize a number of spare blocks of a plurality of first blocks of a first type among the plurality of blocks; and stopping, by the memory controller, the aggressive garbage collection operation in response to a second trigger event, wherein the aggressive garbage collection operation includes executing an uninterrupted garbage collection operation before the second trigger event occurs.

Another aspect of present disclosure relates to a memory device. The memory device is configured to be electrically coupled to an electronic device, and includes a memory module and a memory controller. The memory module includes a plurality of blocks. The memory controller is coupled to the memory module and is configured for: executing an aggressive garbage collection operation in response to an execution command sent by the electronic device, wherein the aggressive garbage collection operation is used to maximize a number of spare blocks of a plurality of first blocks of a first type among the plurality of blocks; and stopping the aggressive garbage collection operation in response to a trigger event, wherein the aggressive garbage collection operation comprises executing an uninterrupted garbage collection operation before the trigger event occurs.

In summary, the electronic device according to the present disclosure can actively and/or passively detect that the user may have the intention to write a massive amount of data into the memory device at high speed, and can trigger the memory device to perform the aggressive garbage collection operation in response to the user's intention, so as to avoid the data transmission speed of the memory device being reduced due to an insufficient number of the spare blocks. In addition to that, the electronic device according to the present disclosure can further report to the user the maximum recording time that can be currently achieved under the video format input by the user, so that the user can determine whether to record the ultra-high-definition video through the electronic device connected to the external memory device or not. As a result, the present disclosure can effectively prevent the user from encountering the situation that the recording of the ultra-high-definition video is accidentally stopped because of the reduced data transmission speed of the memory device. In summary, the electronic device, the memory device, and the triggered data arrangement method of the present disclosure have advantages, such as improving user experience, etc.

### BRIEF DESCRIPTION OF THE DRAWINGS

The present disclosure can be more fully understood by reading the following detailed description of the embodiment, with reference made to the accompanying drawings as follows:

FIG. 1 is a simplified block diagram of an electronic device and a memory device in accordance with some embodiments of the present disclosure;

FIG. 2 is a simplified block diagram of a memory cell of a memory device in accordance with some embodiments of the present disclosure;

FIG. 3 is a flowchart of a triggered data arrangement method in accordance with some embodiments of the present disclosure; and

FIG. 4 is a flowchart of a triggered data arrangement method in accordance with some embodiments of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

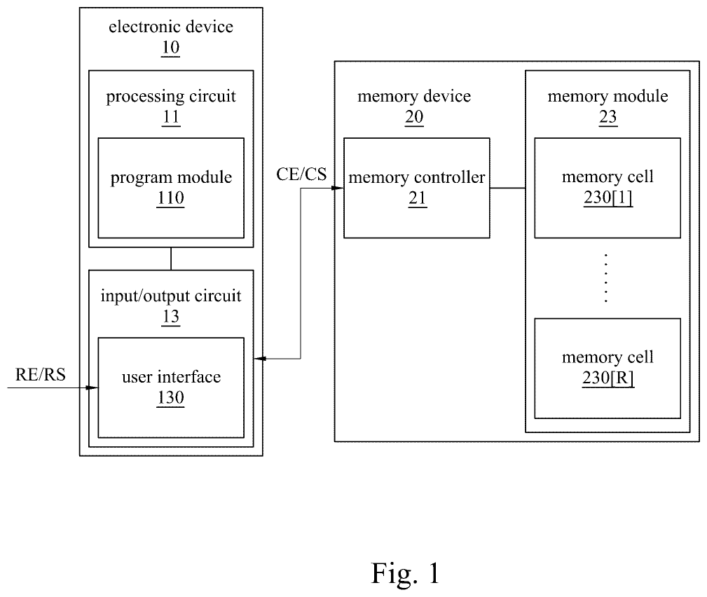

Referring to FIG. 1, FIG. 1 is a simplified block diagram of an electronic device 10 and a memory device 20 in accordance with some embodiments of the present disclosure. In some embodiments, the electronic device 10 and the memory device 20 are configured to be electrically coupled to each other. When the electronic device 10 is electrically coupled to the memory device 20, the electronic device 10 can provide the memory device 20 with power required for operation, and the memory device 20 can provide the electronic device 10 with additional storage space. In greater detail, the electronic device 10 can be implemented by various user devices, such as a smartphone, a tablet computer, a wearable device, a laptop computer, a desktop computer, etc., and the memory device 20 can be implemented by a storage device, such as a portable solid state drive (SSD), etc. It should be understood that the present disclosure is not limited to the above.

In some embodiments, as shown in FIG. 1, the electronic device 10 includes a processing circuit 11 and an input/output (I/O) circuit 13. The processing circuit 11 is electrically coupled to the input/output circuit 13. In greater detail, the processing circuit 11 can be implemented by a combination of various circuits, such as at least one processor, at least one random access memory (for example: a dynamic random access memory (DRAM), a static random access memory (SRAM), etc.), etc., and the input/output circuit 13 can be implemented by a combination of various components, such as at least one sensor (for example: an inertia measurement unit, a light sensor, etc.), a power supply, a display, a camera, a microphone, a speaker, a communicator, a transmission interface, etc.

In some embodiments, the processing circuit 11 is configured to run a program module 110. The program module 110 may include one or more software modules, such as an operating system, a driver, an application program, an application program interface (API), etc. The processing circuit 11 running the program module 110 can control operations of the electronic device 10. For example, the processing circuit 11 running a specific application program can control the above display to display a user interface 130, that is, the processing circuit 11 can run the program module 110, so as to generate the user interface 130 in the input/output circuit 13.

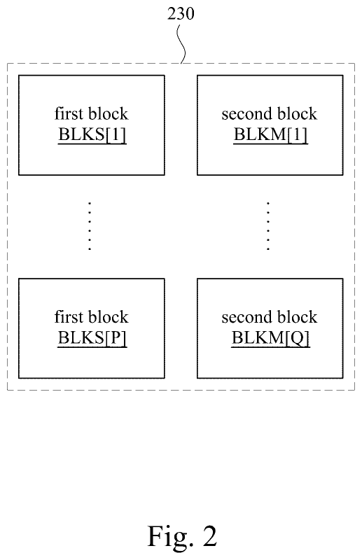

In some embodiments, the memory device 20 includes a memory controller 21 and a memory module 23. The memory controller 21 is electrically coupled to the memory module 23, and is configured to control the memory module 23. The memory module 23 includes a plurality of memory cells 230[1]-230[R]. In greater detail, the memory controller 21 can be implemented by a combination of various circuits, such as a microprocessor, a logic circuit, at least one random access memory, at least one transmission interface, etc. Each of the plurality of memory cells 230[1]-230[R] can be implemented by a non-volatile (NV) memory, and each of the plurality of memory cells 230[1]-230[R] may include a plurality of blocks, which is described in the following paragraphs with reference to FIG. 2. In the embodiment of FIG. 1, R may be a positive integer greater than 1.

Referring to FIG. 2, FIG. 2 is a simplified block diagram of a memory cell 230 of the memory module 23 in accordance with some embodiments of the present disclosure. The memory cell 230 in FIG. 2 may be an example of any one of the plurality of memory cells 230[1]-230[R] in FIG. 1. In some embodiments, as shown in FIG. 2, a plurality of blocks of the memory cell 230 can be divided into a plurality of first blocks BLKS[1]-BLKS[P] and a plurality of second blocks BLKM[1]-BLKM[Q] according to a type of the blocks. In greater detail, each of the plurality of first blocks BLKS[1]-BLKS[P] is a single level cell (SLC) block, and each of the plurality of second blocks BLKM[1]-BLKM[Q] is a multiple level cell (MLC) block, such as a double level cell (DLC) block, a triple level cell (TLC) block, a quadruple level cell (QLC) block, etc. It should be understood by those skilled in the art that a data writing speed of the plurality of first blocks BLKS[1]-BLKS[P] is usually higher than a data writing speed of the plurality of second blocks BLKM[1]-BLKM[Q]. Therefore, in some embodiments, during the period when the memory controller 21 performs a data writing operation on the memory module 23, any blank block in the plurality of first blocks BLKS[1]-BLKS[P] can be used as a cache or spare block for the memory controller 21 to write data into the memory module 23 at a higher data transmission speed. In addition, during the period of data writing operation, the memory controller 21 can periodically perform a garbage collection (GC) operation on the memory module 23, that is, to move or write valid data in the spare block into any blank block in the plurality of second blocks BLKM[1]-BLKM[Q], so as to maintain a number of spare blocks in the memory module 23. In the embodiment of FIG. 2, each of P and Q may be a positive integer greater than 1.

In some practical applications, a user of the electronic device 10 may operate the electronic device 10 to record an ultra-high-definition video (such as a video with a 4K resolution and 120 frames per second (fps)) and store the video in the external memory device 20. Recording of the ultra-high-definition video may require the memory device 20 to support a specific data transmission speed, such as 440 MB per second. That is, when a data transmission speed of the memory device 20 is lower than 440 MB per second, the recording of the ultra-high-definition video will be stopped. If the number of the spare blocks in the memory module 23 is not enough, the memory controller 21 tends to allocate some computing resources to perform the garbage collection operation during the recording of the ultra-high-definition video, thus reducing the data transmission speed of the memory device 20. In short, if the number of the spare blocks in the memory module 23 is insufficient, the recording of the ultra-high-definition video tends to be accidentally stopped due to the reduced data transmission speed of the memory device 20, which results in a bad user experience. For example, the user cannot successfully record an ultra-high-definition video with his/her desired time length by using the electronic device 10 connected to the external memory device 20.

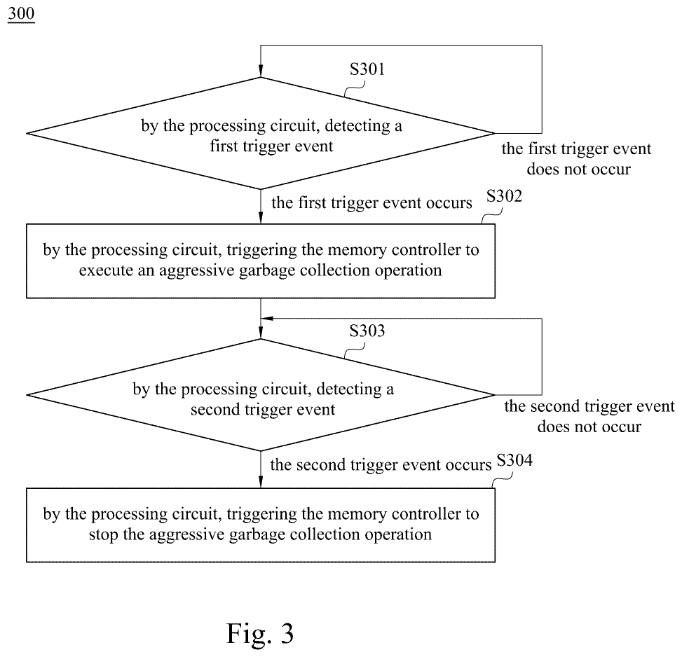

In view of the above problem, the present disclosure provides a technical solution that can allow the memory controller 21 to perform data arrangement on the memory module 23 in advance when the user expects to record an ultra-high-definition video later, which is described in detail with reference to FIG. 3. FIG. 3 is a flowchart of a triggered data arrangement method 300 in accordance with some embodiments of the present disclosure. In some embodiments, the triggered data arrangement method 300 is applicable to the electronic device 10 and the memory device 20. As shown in FIG. 3, the triggered data arrangement method 300 includes a plurality of operations S301-S304.

In operation S301, the processing circuit 11 detects a first trigger event. In some embodiments, if a user expects to use the electronic device 10 connected to the external memory device 20 to record an ultra-high-definition video later, the user can input an execution request RE (as shown in FIG. 1) by operating the electronic device 10, such as clicking a button or some other specific pattern on the user interface 130. When the execution request RE is transmitted to the processing circuit 11 through the input/output circuit 13 in a form of, for example, an electric signal, etc., the processing circuit 11 immediately determines that the first trigger event occurs. In other words, in some embodiments, the first trigger event includes the processing circuit 11 receiving the execution request RE input by the user of the electronic device 10 through the user interface 130, that is, the first trigger event includes the processing circuit 11 receiving the execution request RE transmitted by the electronic device 10 or the electronic device 10 receiving the execution request RE.

The first trigger event of the present disclosure is not limited to the description of the above embodiments. For example, in some embodiments, if the user expects to use the electronic device 10 connected to the external memory device 20 to record the ultra-high-definition video later, the user can connect the electronic device 10 to the memory device 20 through a transmission interface (such as a USB Type-C). Additionally, the processing circuit 11 can detect that the electronic device 10 is electrically connected to the memory device 20 according to a state change of the transmission interface, so as to determine that the first trigger event occurs. That is to say, in some embodiments, the first trigger event includes the processing circuit 11 detecting that the electronic device 10 is electrically connected to the memory device 20.

As shown in FIG. 3, when the first trigger event occurs (that is, when the processing circuit 11 detects the first trigger event), operation S302 is executed. Otherwise, when the first trigger event does not occur (that is, when the processing circuit 11 does not detect the first trigger event), operation S301 will be executed again.

In operation S302, the processing circuit 11 triggers the memory controller 21 to execute an aggressive garbage collection operation. In some embodiments, the processing circuit 11 can send an execution command CE (as shown in FIG. 1) to the memory controller 21 through, for example, a transmission interface in the input/output circuit 13. The memory controller 21 receives the execution command CE and performs the aggressive garbage collection operation in response to the execution command CE.

In some embodiments, the aggressive garbage collection operation is used to maximize a number of spare blocks of a plurality of first blocks BLKS of a first type (that is, single level cell block) among a plurality of blocks of the memory module 23. In greater detail, during the execution period of the aggressive garbage collection operation, the memory controller 21 moves or writes all data stored in the plurality of first blocks BLKS into a plurality of second blocks BLKM of a second type (that is, multiple level cell block) among the plurality of blocks of the memory module 23. In other words, the aggressive garbage collection operation includes executing an uninterrupted garbage collection operation. In addition to that, as can be understood from the above description, in some embodiments a number of level (such as single level) of cells of the first type is lower than a number of level (such as multiple level) of cells of the second type. In some further embodiments, an available capacity of the plurality of second blocks BLKM may not be sufficient to allow the memory controller 21 to move or write all the data stored in the plurality of fist blocks BLKS into the plurality of second blocks BLKM. Under this circumstance, the memory controller 21 will move or write the data stored in the plurality of first blocks BLKS into the plurality of second blocks BLKM according to the available capacity of the plurality of second blocks BLKM. That is, the memory controller 21 moves or writes the data in the plurality of first blocks BLKS that is substantially the same size as the available capacity of the plurality of second blocks BLKM into the plurality of second blocks BLKM, so as to maximize the number of the spare blocks of the plurality of first blocks BLKS.

In some embodiments, operation S303 can be executed during the execution period of the aggressive garbage collection operation. In operation S303, the processing circuit 11 detects a second trigger event. In some embodiments, the user determines that the ultra-high-definition video with his/her expected time length can be successfully recorded, and can input a stop request RS (as shown in FIG. 1) by operating the electronic device 10, such as clicking a button or some other specific pattern on the user interface 130. When the stop request RS is transmitted to the processing circuit 11 through the input/output circuit 13 in the form of, for example, the electrical signal, etc., the processing circuit 11 immediately determines that the second trigger event occurs. In other words, in some embodiments, the second trigger event includes the processing circuit 11 receiving the stop request RS input by the user of the electronic device 10 through the user interface 130, that is, the second trigger event includes the processing circuit 11 receiving the stop request RS transmitted by the electronic device 10 or the electronic device 10 receiving the stop request RS.

As shown in FIG. 3, when the second trigger event occurs (that is, when the processing circuit 11 detects the second trigger event), operation S304 is executed. Otherwise, when the second trigger event does not occur (that is, when the processing circuit 11 does not detect the second trigger event), operation S303 will be executed again.

In operation S304, the processing circuit 11 triggers the memory controller 21 to stop the aggressive garbage collection operation. In some embodiments, the processing circuit 11 can send a stop command CS (as shown in FIG. 1) to the memory controller 21 through, for example, the transmission interface in the input/output circuit 13. The memory controller 21 receives the stop command CS and stops the aggressive garbage collection operation in response to the stop command CS.

As can be understood from the description of the embodiment of FIG. 3, the memory controller 21 executes the uninterrupted aggressive garbage collection operation before the second trigger event occurs. That is, the aggressive garbage collection operation can only be stopped by the second trigger event. Such an arrangement can effectively reduce the occurrence of accidental stopping of recording of the ultra-high-definition video due to a reduced data transmission speed of the memory device 20.

It should be understood that the second trigger event of the present disclosure is not limited to the description of the above embodiment. For example, in some embodiments, the memory controller 21 can determine whether the number of the spare blocks of the plurality of first blocks BLKS has been maximized or not according to an available capacity of the plurality of first blocks BLKS and/or the available capacity of the plurality of second blocks BLKM. When the available capacity of the plurality of first blocks BLKS is equal to a preset maximum capacity, or when the available capacity of the plurality of second blocks BLKM is substantially zero, the memory controller 21 can determine that the number of the spare blocks of the plurality of first blocks BLKS has been maximized, and further determine that the second trigger event occurs. That is to say, in some embodiments, the second trigger event includes that the number of the spare blocks of the plurality of first blocks BLKS has been maximized, and can be detected by the memory controller 21. In addition, when the memory controller 21 detects that the number of the spare blocks of the plurality of first blocks BLKS has been maximized, the memory controller 21 stops the aggressive garbage collection operation. Additionally, in some embodiments, the processing circuit 11 can be notified of the number of the spare blocks of the plurality of first blocks BLKS by the memory controller 21, and further can detect a trigger event that the number of the spare blocks of the plurality of first blocks BLKS has been maximized.

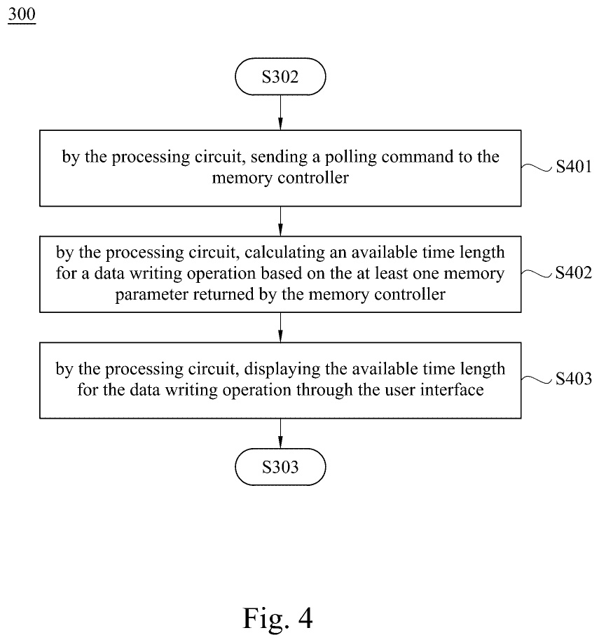

In some embodiments, the user can determine whether an ultra-high-definition video with his/her expected time length can be successfully recorded or not through the user interface 130 on the electronic device 10, which is described with reference to FIG. 4. FIG. 4 is a flowchart of the triggered data arrangement method 300 in accordance with some embodiments of the present disclosure. In some embodiments, as shown in FIG. 4, the triggered data arrangement method 300 includes a plurality of operations S401-S403, and the plurality of operations S401-S403 can be executed between operation S302 and operation S303, that is, which can be executed during the execution period of the aggressive garbage collection operation.

In operation S401, the processing circuit 11 sends a polling command to the memory controller 21. In some embodiments, the processing circuit 11 sends the polling command to the memory controller 21 through, for example, the transmission interface in the input/output circuit 13 to request at least one memory parameter from the memory controller 21. The memory controller 21 receives the polling command and returns the at least one memory parameter in response to the polling command. In greater detail, the at least one memory parameter may include the number of the spare blocks of the plurality of first blocks BLKS and/or a configuration of the memory module 23 (such as a number of channels, a total capacity, etc.).

In operation S402, the processing circuit 11 calculates an available time length for a data writing operation based on the at least one memory parameter returned by the memory controller 21. In some embodiments, the data writing operation may correspond to a video format (such as resolution, fps, etc.) that the user will later record by using the electronic device 10 connected to the external memory device 20. The processing circuit 11 can calculate the available time length for the data writing operation based on a capacity corresponding to the number of the spare blocks of the plurality of first blocks BLKS and a data transmission speed required by the data writing operation. In greater detail, the user can input the video format to be recorded later by him/her through the user interface 130, and the processing circuit 11 can obtain the data transmission speed correspondingly. In some embodiments, the at least one memory parameter may include a capacity of the plurality of first blocks BLKS, so the processing circuit 11 can directly know the capacity corresponding to the number of the spare blocks of the plurality of first blocks BLKS, and calculate the available time length for the data writing operation accordingly. In some further embodiments, the processing circuit 11 can divide the capacity corresponding to the number of the spare blocks of the plurality of first blocks BLKS (such as 233 GB) by the data transmission speed required by the data writing operation (such as 440 MB per second) to calculate the available time length for the data writing operation (such as 529 seconds). This time length also represents a maximum recording time that can be currently achieved under the video format input by the user.

In operation S403, the processing circuit 11 displays the available time length for the data writing operation through the user interface 130. In some embodiments, the user can determine whether the available time length for the data writing operation displayed on the user interface 130 meets his/her requirement for video time length or not, that is, whether the available time length for the data writing operation is longer than his/her expected video time length (such as 10 minutes) or not.

In some embodiments, the user determines that the available time length for the data writing operation displayed on the user interface 130 is sufficient, and inputs the stop request RS through the user interface 130. Under this circumstance, the processing circuit 11 detects the second trigger event in operation S303. In some embodiments, the user determines that the available time length for the data writing operation displayed on the user interface 130 is insufficient, and thus does not perform an operation through the user interface 130. Under this circumstance, the processing circuit 11 does not detect the second trigger event in operation S303, so that the plurality of operations S401-S403 can be performed again in sequence. That is to say, the processing circuit 11 can periodically report to the user through the user interface 130 the maximum recording time that can be currently achieved under the video format input by the user.

Next, the memory device 20 being a portable solid state drive with a capacity of 1 TB is taken as an example for further illustration. When the plurality of first blocks BLKS in the memory device 20 store 200 GB of data, a spare capacity of the plurality of first blocks BLKS in the memory device 20 with the capacity of 1 TB is equivalent to 133 GB. Under this circumstance, if the data transmission speed required by the data writing operation corresponding to the video format input by the user is 440 MB per second, the available time length for the data writing operation is 302 seconds. It is noted that when the 200 GB of data stored in the plurality of first blocks BLKS are all moved or written into the plurality of second blocks BLKM through the aggressive garbage collection operation, the spare capacity of the plurality of first blocks BLKS in the memory device 20 with the capacity of 1 TB can be equivalent to 267 GB. Under this circumstance, if the data transmission speed required by the data writing operation corresponding to the video format input by the user is 440 MB per second, the available time length for the data writing operation is 606 seconds. It is thus understood that, by performing the aggressive garbage collection operation to maximize the number of the spare blocks of the plurality of first blocks BLKS (that is, the spare capacity), the maximum recording time that can be currently achieved under the video format input by the user can be significantly increased to easily meet the need of the user. At the same time, the user is allowed to complete the video recording by using the relatively low-priced memory device 20.

It is thus understood from the previously mentioned embodiments of the present disclosure, that the electronic device 10 according to the present disclosure can actively and/or passively detect that the user may have the intention to write a massive amount of data into the memory device 20 at high speed (for example, the processing circuit 10 detects that the electronic device 10 is electrically connected to the memory device 20, the user inputs the execution request RE through the user interface 130, etc.), and can trigger the memory device 20 to perform the aggressive garbage collection operation in response to the user's intention, so as to avoid the data transmission speed of the memory device 20 being reduced due to an insufficient number of the spare blocks with a faster data writing speed. In addition to that, the electronic device 10 according to the present disclosure can further actively report to the user the maximum recording time that can be currently achieved under the video format input by the user, so that the user can determine whether to record the ultra-high-definition video through the electronic device 10 connected to the external memory device 20 or not. As a result, the present disclosure can effectively prevent the user from encountering the situation that the recording of the ultra-high-definition video is accidentally stopped because of the reduced data transmission speed of the memory device 20. In summary, the electronic device 10, the memory device 20, and the triggered data arrangement method 300 of the present disclosure have advantages, such as improving user experience, etc.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A triggered data arrangement method, applicable to an electronic device and a memory device, wherein the memory device comprises a memory controller and a memory module, the memory module comprises a plurality of blocks, and the triggered data arrangement method comprises:
triggering, by a processing circuit of the electronic device, the memory controller to execute an aggressive garbage collection operation in response to the processing circuit detecting a first trigger event, wherein the aggressive garbage collection operation is used to maximize a number of spare blocks of a plurality of first blocks of a first type among the plurality of blocks; and
stopping, by the memory controller, the aggressive garbage collection operation in response to a second trigger event, wherein the aggressive garbage collection operation comprises executing an uninterrupted garbage collection operation before the second trigger event occurs.

2. The triggered data arrangement method of claim 1, further comprising:
detecting, by the processing circuit, the first trigger event, wherein the first trigger event comprises the processing circuit receiving an execution request transmitted by the electronic device and/or the processing circuit detecting that the electronic device is electrically connected to the memory device.

3. The triggered data arrangement method of claim 1, further comprising:
detecting, by the processing circuit, the second trigger event, wherein the second trigger event comprises at least one of the following: the processing circuit receiving a stop request transmitted by the electronic device and the number of the spare blocks of the plurality of first blocks having been maximized; and
triggering, by the processing circuit, the memory controller to stop the aggressive garbage collection operation in response to the processing circuit detecting the second trigger event.

4. The triggered data arrangement method of claim 3, wherein the aggressive garbage collection operation can only be stopped by the second trigger event, and the second trigger event only comprises at least one of the following: the processing circuit receiving the stop request transmitted by the electronic device and the number of the spare blocks of the plurality of first blocks having been maximized.

5. The triggered data arrangement method of claim 1, wherein the aggressive garbage collection operation comprises:
moving, by the memory controller, data of at least one of the plurality of first blocks to at least one of a plurality of second blocks of a second type among the plurality of blocks, wherein a number of level of cells of the first type is lower than a number of level of cells of the second type.

6. The triggered data arrangement method of claim 1, further comprising:
displaying, by the processing circuit, an available time length for a data writing operation of the memory device through a user interface during an execution period of the aggressive garbage collection operation.

7. The triggered data arrangement method of claim 6, further comprising:
calculating, by the processing circuit, the available time length for the data writing operation based on at least one memory parameter returned by the memory controller.

8. The triggered data arrangement method of claim 7, wherein the at least one memory parameter at least comprises the number of the spare blocks of the plurality of first blocks or a capacity of the plurality of first blocks, and calculating the available time length based on the at least one memory parameter comprises:
calculating the available time length based on a data transmission speed required by the data writing operation and one of the capacity and the number of the spare blocks.

9. The triggered data arrangement method of claim 7, further comprising:
sending, by the processing circuit, a polling command to the memory controller, wherein the polling command is used to request the at least one memory parameter from the memory controller.

10. A memory device, configured to be electrically coupled to an electronic device, and comprising:
a memory module, comprising a plurality of blocks; and
a memory controller, coupled to the memory module and being configured for:
executing an aggressive garbage collection operation in response to an execution command sent by the electronic device, wherein the aggressive garbage collection operation is used to maximize a number of spare blocks of a plurality of first blocks of a first type among the plurality of blocks; and
stopping the aggressive garbage collection operation in response to a trigger event, wherein the aggressive garbage collection operation comprises executing an uninterrupted garbage collection operation before the trigger event occurs.

11. The memory device of claim 10, wherein the electronic device sends the execution command in response to receiving an execution request and/or detecting that the electronic device is electrically connected to the memory device.

12. The memory device of claim 10, wherein the trigger event comprises the memory controller receiving a stop command sent by the electronic device.

13. The memory device of claim 12, wherein the electronic device sends the stop command in response to receiving a stop request and/or detecting that the number of the spare blocks of the plurality of first blocks has been maximized.

14. The memory device of claim 10, wherein the trigger event comprises that the memory controller determines that the number of the spare blocks of the plurality of first blocks has been maximized.

15. The memory device of claim 10, wherein the aggressive garbage collection operation can only be stopped by the trigger event, and the trigger event only comprises at least one of the following: the electronic device receiving a stop request and the number of the spare blocks of the plurality of first blocks having been maximized.

16. The memory device of claim 10, wherein the memory controller is configured to move data of at least one of the plurality of first blocks to at least one of a plurality of second blocks of a second type among the plurality of blocks so as to maximize the number of the spare blocks of the plurality of first blocks, wherein a number of level of cells of the first type is lower than a number of level of cells of the second type.

17. The memory device of claim 10, wherein the memory controller is further configured to return at least one memory parameter in response to a polling command sent by the electronic device during an execution period of the aggressive garbage collection operation, wherein the electronic device calculates an available time length for a data writing operation of the memory device based on the at least one memory parameter.

18. The memory device of claim 17, wherein the at least one memory parameter at least comprises the number of the spare blocks of the plurality of first blocks or a capacity of the plurality of first blocks, and the electronic device calculates the available time length based on a data transmission speed required by the data writing operation and one of the capacity and the number of the spare blocks.

19. The memory device of claim 17, wherein the electronic device displays the available time length for the data writing operation through a user interface during the execution period of the aggressive garbage collection operation.
